(19) United States
(12) Patent Application Publication
(10) Pub. No.: US 2025/0306958 A1
(43) Pub. Date: Oct. 2, 2025

(54) PAGE DISPLAY METHOD, A READABLE MEDIUM, AND AN ELECTRONIC DEVICE

(71) Applicant: Beijing Youzhuju Network Technology Co., Ltd., Beijing (CN)

(72) Inventor: Haiyuan WU, Beijing (CN)

(21) Appl. No.: 18/991,221

(22) Filed: Dec. 20, 2024

(30) Foreign Application Priority Data
Mar. 29, 2024 (CN) 202410383397.0

(51) Int. Cl. G06F 9/445; G06F 9/451

(52) U.S. Cl. CPC G06F 9/44505; G06F 9/451

(57) ABSTRACT

The present disclosure relates to a page display method and apparatus, a readable medium, and an electronic device. The method includes: determining a target opening manner for a target page in response to a trigger operation on the target page within an application, wherein the target opening manner is used to represent whether to open the target page within the application; and displaying the target page based on the target opening manner.

### CROSS-REFERENCE TO RELATED APPLICATION

This application claims the priority to and benefits of the Chinese Patent Application, No. 202410383397.0, which was filed on Mar. 29, 2024. The aforementioned patent application is hereby incorporated by reference in its entirety.

### TECHNICAL FIELD

The present disclosure relates to the field of computer technologies, and in particular, to a page display method and apparatus, a readable medium, and an electronic device.

### BACKGROUND

An application (App) can implement information interaction between a user and the application through a display page. In the related art, a page of an application is typically displayed based on a default opening manner, which makes a page display manner of the application lack flexibility.

### SUMMARY

The summary is provided to give a brief overview of concepts, which will be described in detail later in the detailed description section. The summary is neither intended to identify key or necessary features of the claimed technical solutions, nor is it intended to be used to limit the scope of the claimed technical solutions.

According to a first aspect, the present disclosure provides a page display method, including:
determining a target opening manner for a target page in response to a trigger operation on the target page within an application, where the target opening manner is used to represent whether to open the target page within the application; and
displaying the target page based on the target opening manner.

According to a second aspect, the present disclosure further provides a page display apparatus, including:
a determining module configured to determine a target opening manner for a target page in response to a trigger operation on the target page within an application, where the target opening manner is used to represent whether to open the target page within the application; and
a display module configured to display the target page based on the target opening manner.

According to a third aspect, the present disclosure provides a computer-readable medium with a computer program stored thereon, wherein the program, when executed by a processing apparatus, causes the steps of the method according to any one of the first aspect to be implemented.

According to a fourth aspect, the present disclosure provides an electronic device, including:
a storage apparatus with a computer program stored thereon; and
a processing apparatus configured to execute the computer program in the storage apparatus to implement the steps of the method according to any one of the embodiments of the first aspect.

The other features and advantages of the present disclosure will be described in detail in the following detailed description section.

### BRIEF DESCRIPTION OF DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale. In the accompanying drawings:

FIG. 1 is a flowchart of a page display method according to an exemplary embodiment of the present disclosure;

FIG. 2 is a flowchart of determining a target opening manner for a target page according to an exemplary embodiment of the present disclosure;

FIGS. 3(a) and 3(b) are schematic diagrams of display of a target page opened within and outside an application according to an exemplary embodiment of the present disclosure;

FIG. 4 is another flowchart of determining a target opening manner for a target page according to an exemplary embodiment of the present disclosure;

FIG. 5 is another flowchart of determining a target opening manner for a target page according to an exemplary embodiment of the present disclosure;

FIG. 6 is another flowchart of determining a target opening manner for a target page according to an exemplary embodiment of the present disclosure;

FIG. 7 is another flowchart of determining a target opening manner for a target page according to an exemplary embodiment of the present disclosure;

FIG. 8 is a block diagram of a structure of a page display apparatus according to an exemplary embodiment of the present disclosure; and

FIG. 9 is a schematic diagram of a structure of an electronic device according to an exemplary embodiment of the present disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

Furthermore, it can be understood that the data involved in the technical solutions (including, but not limited to, the data itself and the access to or use of the data) shall comply with the requirements of corresponding laws, regulations, and relevant provisions.

As stated in the background art, an application can implement information interaction between a user and the application through a display page. In the related art, a page of an application is typically displayed based on a default opening manner, which makes a page display manner of the application lack flexibility.

In view of this, the present disclosure provides a page display method and apparatus, a readable medium, and an electronic device, to solve the above technical problems.

The embodiments of the present disclosure are further explained and described below with reference to the accompanying drawings.

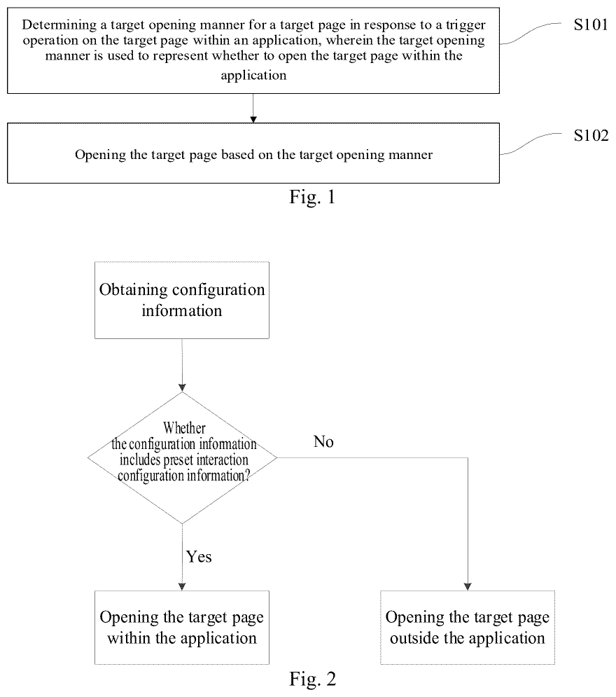

FIG. 1 is a flowchart of a page display method according to an exemplary embodiment of the present disclosure. With reference to FIG. 1, the method may include the following steps:

S101: determining a target opening manner for a target page in response to a trigger operation on the target page within an application, wherein the target opening manner is used to represent whether to open the target page within the application.

It should be understood that the target page can be determined according to actual situations, which is not limited in this embodiment of the present disclosure. For example, the target page may be an information promotion page landing page, a breaking news page, a page that a user is interested in, or the like. The application may be a different type of application, such as a video application, which is also not limited in this embodiment of the present disclosure.

Taking the video application as an example, the video application may display a video to a user in the form of a video stream. The user may watch different videos by swiping through the video stream, and at least one target video in the video stream is associated with a target page. When the user is about to watch a target video by swiping through the video stream, it can be determined that the trigger operation on the target page is generated. Then, the target opening manner for the target page may be determined in response to the trigger operation on the target page.

S102: opening the target page based on the target opening manner.

For example, when the target opening manner is used to represent that the target page is to be opened within the application, the target page may be opened based on a browser embedded within the application. When the target opening manner is used to represent that the target page is to be opened outside the application, the target page may be opened based on a browser in a terminal device running the application. The terminal device may be a mobile terminal device, such as a mobile phone, a wearable device, or a tablet computer, or may be a non-mobile terminal device, such as a computer, which is not limited in this embodiment of the present disclosure. The browser in the terminal device may be any browser in the terminal device, or may be a browser frequently used in the terminal device, or may be a default browser in the terminal device, which is not limited in this embodiment of the present disclosure.

By continuing to take the above video application as an example, after the target opening manner for the target page is determined, when the target opening manner represents that the target page is to be opened within the application, the target page may be displayed at an upper layer of the video stream. For example, the target page may be displayed in a full screen at the upper layer of the video stream, that is, the display of the target page completely covers the display of the video stream. In other cases, when the target opening manner represents that the target page is to be opened outside the application, a jump may be made from the application to the default browser in the terminal device running the application, and then the target page is displayed within the default browser.

Through the above technical solution, when the target page is triggered to be displayed within the application, the target opening manner for the target page can be determined, such that the target page can be displayed based on the target opening manner. Since the target opening manner is used to represent whether to open the target page within the application, the same target page may be opened and displayed within the application, or may be opened and displayed outside the application. Compared with the solution that the same page is generally displayed based on a default opening manner in the related art, the solution provided by the present disclosure can dynamically adjust the page opening manner of the application, thereby improving the flexibility of page display, and also improving the user experience.

In a possible implementation, determining the target opening manner for the target page in response to the trigger operation on the target page within the application may include:
obtaining, in response to the trigger operation on the target page within the application, configuration information of the target page and/or historical interaction matching information of a terminal device running the application, wherein the historical interaction matching information is used to represent interaction matching information for page interaction based on a historical page, and the historical page is a page with a same page type as the target page;
and determining the target opening manner for the target page based on the configuration information and/or the historical interaction matching information.

It should be understood that before obtaining the historical interaction matching information, the user should be informed in accordance with relevant laws and regulations, and authorization of the user should be obtained. For example, when the user uses the application for the first time, prompt information may be sent to the user to clearly inform the user that the use of the application will require access to and use of personal information of the user. As such, the user can independently choose, based on the prompt information, whether to provide the personal information to software or hardware, such as an electronic device, an application, a server, or a storage medium, that performs operations in the technical solutions of the present disclosure.

In a possible implementation, as shown in FIG. 2, determining the target opening manner for the target page based on the configuration information may include:
determining to open the target page within the application when the configuration information includes preset interaction configuration information; or determining to open the target page outside the application when the configuration information does not include the preset interaction configuration information.

The preset interaction configuration information may be preset interactive action information for interacting with the target page, where interactive actions include, for example, opening a page, browsing a page content for a preset time, viewing target information in a page, or the like. Correspondingly, when the configuration information includes the preset interactive action information, the target page is opened within the application, such that a page loading speed can be faster, and the user experience can be improved.

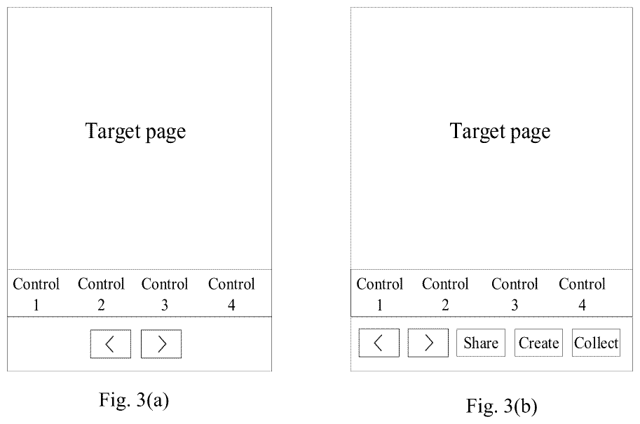

In different application scenarios, different interactive actions can be performed within the target page. Due to limited interaction controls within the application, as shown in FIG. 3(a), when the target page is opened within the application, no matter whether the target page is capable to perform complex interactive actions, only some simple interaction operations can be performed within the target page, resulting in poor user interaction with the target page and affecting the user experience. The application used to open the target page outside the application may provide more diversified functions, such that opening the target page outside the application may satisfy more interaction needs of the user. For example, as shown in FIG. 3(b), the target page is opened by using the browser in the terminal device. Since the browser has the functions of page bookmarking, page sharing and/or page creating, other display pages may be created while the target page is retained, or the target page may be bookmarked and shared before exiting the browser, so as to quickly retrieve the target page when the browser is subsequently opened. Therefore, in a possible implementation, whether to open the target display page within the application or open the target display page outside the application may be determined based on the complexity of the interactive actions that can be performed within the target page, that is, a target page configured with simple interactive actions may be opened within the application, and a target page configured with complex interactive actions may be opened outside the application.

Through the above technical solution, the target opening manner for the target page may be determined based on the preset interaction configuration information. Since the preset interaction configuration information may reflect the complexity of the interactive action that can be performed within the target page, whether to open the target display page within the application or open the target display page outside the application may be determined based on the complexity of the interactive action that can be performed within the target page. Compared with the solution that a target page is opened based on a default opening manner in the related art, the present disclosure may dynamically adjust the opening manner for the target page based on the complexity of the interactive action that can be performed in the target page, thereby improving the user experience.

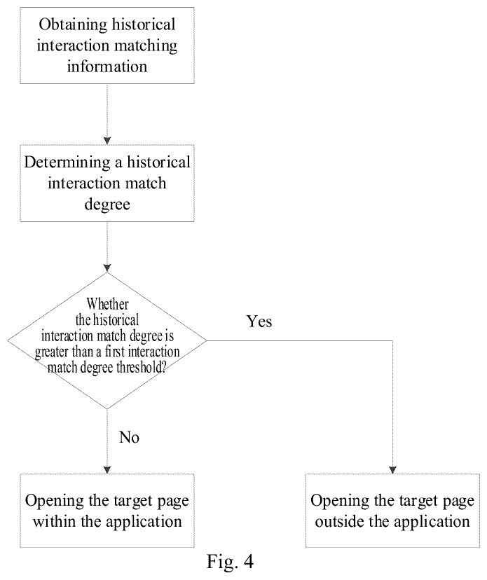

In a possible implementation, as shown in FIG. 4, determining the target opening manner for the target page based on the historical interaction matching information may include:
determining a historical interaction match degree based on the historical interaction matching information, wherein the historical interaction match degree is an interaction match degree for the page interaction based on the historical page when the historical page is displayed through a default browser in the terminal device running the application; and
determining to open the target page outside the application when the historical interaction match degree is greater than a preset first interaction match degree threshold; or determining to open the target page within the application when the historical interaction match degree is less than or equal to the first interaction match degree threshold

It should be understood that the first interaction match degree threshold may be set according to actual situations, which is not limited in this embodiment of the present disclosure. For example, the first interaction match degree threshold may be set to 50% or 80%.

In this embodiment, a number A of historical pages where page interaction occurs among all the historical pages may be counted, and a number B of historical pages where page interaction occurs in the default browser may be counted. Then, the historical interaction match degree is obtained by determining a ratio of the number B to the number A. Herein, the manners of obtaining and using personal information may be found in the beginning of the detailed description of the present disclosure, which satisfy the relevant laws and regulations.

It should be understood that this is merely an adaptive description and does not limit the solutions. In a possible manner, the historical interaction match degree may alternatively be obtained based on the historical interaction matching information and a match degree prediction model. The match degree prediction model may be trained based on sample interaction matching information and corresponding interaction match degrees.

Through the above technical solution, the opening manner for the target page may be determined based on the historical interaction match degree and the first interaction match degree threshold. Since the historical interaction match degree reflects a current user preference for page interaction within or outside the application, whether to open the target display page within the application or open the target display page outside the application may be determined based on the user preference. Compared with the solution that the target page is opened based on the default opening manner in the related art, the present disclosure may dynamically adjust the opening manner for the target page based on the user preferences of different users, so as to better satisfy different needs of different users or needs of the same user at different stages, and improve the user experience.

In a possible implementation, determining the target opening manner for the target page based on the historical interaction matching information may include:

determining a historical interaction match degree and historical page content based on the historical interaction matching information, wherein the historical interaction match degree is an interaction match degree of page interaction based on the historical page when the historical page is displayed through a default browser in the terminal device running the application, and the historical page content is content of the historical page associated with page interaction information; and determining the target opening manner for the target page based on the historical interaction match degree and the historical page content matching information.

The page interaction information refers to information that undergoes page interaction, such as an interacted identifier. Therefore, by the page interaction information, historical pages where page interaction occurs in the current terminal device may be determined. In other words, the historical page associated with the page interaction information is a page where page interaction has occurred in the current terminal device. Correspondingly, the historical page content may be the content of the historical page where page interaction occurs.

The historical page content may be set according to actual situations, which is not limited in this embodiment of the present disclosure. In a possible implementation, the historical page content may include a domain name of the historical page, or a content identifier in the historical page.

The content identifier may be a content type, such as an electronic product type, a clothing type or a household type. The content identifier may alternatively be a content publisher, which is not limited in this embodiment of the present disclosure.

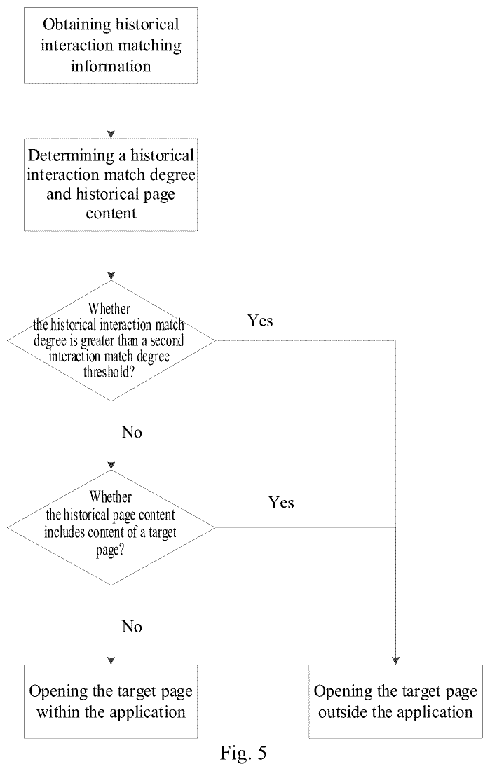

In a possible implementation, as shown in FIG. 5, determining the target opening manner for the target page based on the historical interaction match degree and the historical page content may include:
determining to open the target page outside the application when the historical interaction match degree is greater than a preset second interaction match degree threshold; determining to open the target page outside the application when the historical interaction match degree is less than or equal to the second interaction match degree threshold and the historical page content includes content of the target page; or determining to open the target page within the application when the historical interaction match degree is less than or equal to the second interaction match degree threshold and the historical page content does not include the content of the target page.

The first interaction match degree threshold and the second interaction match degree threshold may be the same or different, which is not limited in this embodiment of the present disclosure.

Through the above technical solution, the opening manner for the target page may be determined based on the historical interaction match degree, the second interaction match degree threshold, the historical page content, and the content of the target page. Since the historical interaction match degree reflects the current user preference for page interaction within the application or outside the application, and the historical page content reflects what kind of content the current user prefers to interact with, whether to open the target display page within the application or open the target display page outside the application may be determined based on user characteristics. Compared with the solution that the target page is opened based on the default opening manner in the related art, the present disclosure may dynamically adjust the opening manner for the target page based on the user characteristics, so as to better satisfy different needs of different users or needs of the same user at different stages, and improve the user experience.

It should be understood that a determination of the target opening manner for the target page based on the historical interaction matching information mentioned above is merely illustrative and does not constitute a limitation on the solution. In a possible implementation, determining the target opening manner for the target page based on the historical interaction matching information may alternatively include: the historical interaction match degree is determined at first based on the historical interaction matching information, and then whether the historical interaction match degree is greater than the preset second interaction match degree threshold is determined. When the historical interaction match degree is greater than the preset second interaction match degree threshold, opening the target page outside the application is used as the target opening manner. When the historical interaction match degree is less than or equal to the preset second interaction match degree threshold, a domain name or content identifier of the target page is obtained, and then whether a page where page interaction has occurred is present in the browser of the terminal device under the domain name or content identifier is determined. If the page where page interaction has occurred is present, opening the target page outside the application is used as the target opening manner. If the page where page interaction has occurred is not present, opening the target page within the application is used as the target opening manner.

In a possible implementation, determining the target opening manner for the target page based on the configuration information and the historical interaction matching information may include:
determining the target opening manner for the target page based on the historical interaction matching information when the configuration information does not include preset interaction configuration information.

The determination of the target opening manner for the target page based on the historical interaction matching information may be in a first determining manner (i.e. determining the historical interaction match degree based on the historical interaction matching information, and determining the target opening manner for the target page based on the historical interaction match degree), or may be in a second determining manner (determining the historical interaction match degree and the historical page content based on the historical interaction matching information, and determining the target opening manner for the target page based on the historical interaction match degree and the historical page content), which is not limited in this embodiment. This embodiment will be explained here with the second determining manner as an example.

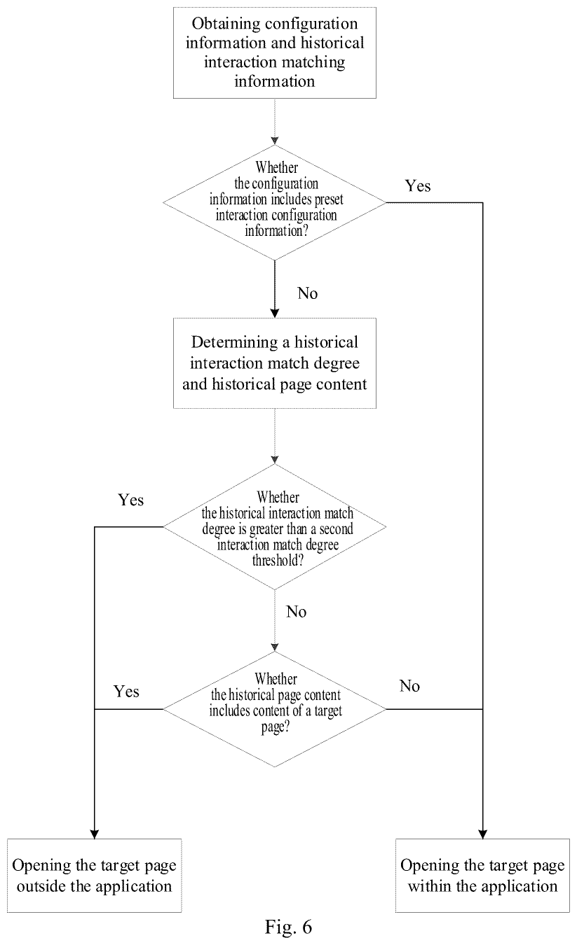

Specifically, as shown in FIG. 6, when the configuration information and the historical interaction matching information are obtained, whether the configuration information contains preset interaction configuration information is determined at first. When the configuration information contains the preset interaction configuration information, opening the target page within the application is used as the target opening manner. When the configuration information does not contain the preset interaction configuration information, the historical interaction match degree and the historical page content are determined at first based on the historical interaction matching information, and then whether the historical interaction match degree is greater than the preset second interaction match degree threshold is determined. When the historical interaction match degree is greater than the preset second interaction match degree threshold, opening the target page outside the application is used as the target opening manner. When the historical interaction match degree is less than or equal to the preset second interaction match degree threshold, whether the historical page content includes the content of the target page is then determined. When the historical page content includes the content of the target page, opening the target page outside the application is used as the target opening manner, and when the historical page content does not include the content of the target page, opening the target page within the application is used as the target opening manner.

Through the above technical solution, the target opening manner for the target page may be determined based on the configuration information and the historical interaction matching information. Since the configuration information reflects the complexity of the interactive action that can be performed in the target page, and the historical interaction matching information reflects the user characteristics, the opening manner for the target page may be dynamically adjusted based on the complexity of the interactive action that can be performed in the target page and the user characteristics. Compared with the solution of opening the target page based on the default opening manner in the related art, the present disclosure may dynamically adjust the opening manner for the target page based on the complexity of the interactive action that can be performed in the target page and the user characteristics, so as to better satisfy different needs of different users or needs of the same user at different stages, and improve the user experience.

In a possible implementation, determining the target opening manner for the target page may include:
determining to open the target page outside the application when the target page is unable to be opened within the application.

It should be understood that the problem that the target page is unable to be opened within the application may be caused by reasons such as page access restrictions or technical restrictions of the application. To overcome the above problem, whether the target page can be opened within the application may be determined when it is determined to open the target page within the application, When the target page can be opened within the application, opening the target page within the application is determined as the target opening manner. When the target page is unable to be opened within the application, opening the target page outside the application is used as the target opening manner.

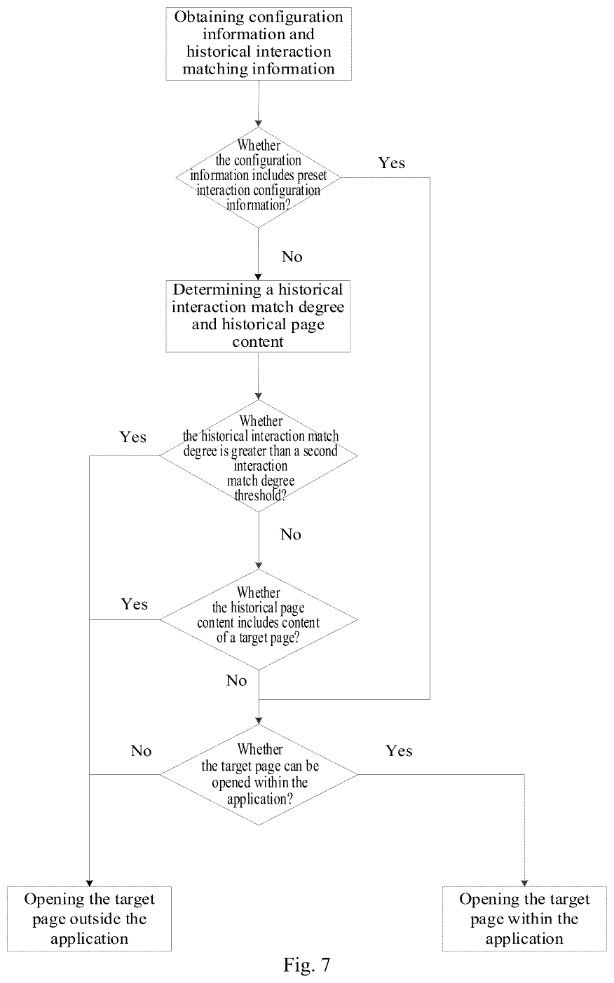

For example, as shown in FIG. 7, when the configuration information and the historical interaction matching information are obtained, whether the configuration information contains the preset interaction configuration information is determined at first. When the configuration information contains the preset interaction configuration information, whether the target page can be opened within the application is determined. When the target page can be opened within the application, opening the target page within the application is used as the target opening manner. When the target page is unable to be opened within the application, opening the target page outside the application is used as the target opening manner. When the configuration information does not contain the preset interaction configuration information, the historical interaction match degree and the historical page content are determined at first based on the historical interaction matching information, and then whether the historical interaction match degree is greater than the preset second interaction match degree threshold is determined. When the historical interaction match degree is greater than the preset second interaction match degree threshold, opening the target page outside the application is used as the target opening manner. When the historical interaction match degree is less than or equal to the preset second interaction match degree threshold, whether the historical page content includes the content of the target page is then determined. When the historical page content contains the content of the target page, opening the target page outside the application is used as the target opening manner. When the historical page content does not contain the content of the target page, whether the target page can be opened within the application is determined. When the target page can be opened within the application, opening the target page within the application is used as the target opening manner. When the target page is unable to be opened within the application, opening the target page outside the application is used as the target opening manner.

The page access restrictions refer to: access restrictions are set on some pages, and the pages can only be accessed through specific browsers or devices. The technical restrictions of the application refer to: some applications may lack specific technologies or functions being necessary to support some pages. For example, some pages may depend on a specific page display technology that is not supported by most applications, so these pages that depend on the specific page display technology cannot be opened within the application.

Through the above technical solution, when the target page cannot be opened within the application, opening the target page outside the application is used as the target opening manner. Therefore, it can be ensured that the target page is opened and displayed normally.

It should be understood that the determination of the target opening manner for the target page based on the configuration information and/or the historical interaction matching information mentioned above is merely illustrative and does not constitute a limitation on the solution. In a possible implementation, the target opening manner for the target page may alternatively be determined based on the configuration information and/or the historical interaction matching information by a neural network model. That is, according to an embodiment of the present disclosure, determining the target opening manner for the target page based on the configuration information and/or the historical interaction matching information may include:
inputting the configuration information and/or the historical interaction matching information into a prediction model, determining a predicted opening manner output by the prediction model as the target opening manner for the target page, wherein the prediction model is used to determine a page opening manner based on input information.

For example, a prediction model may be trained in advance with configuration information samples and historical interaction matching information samples as inputs, and target opening manner samples as outputs. Then, truly obtained configuration information and historical interaction matching information are input into the prediction model, such that the prediction model can determine the target opening manner based on the input configuration information and historical interaction matching information.

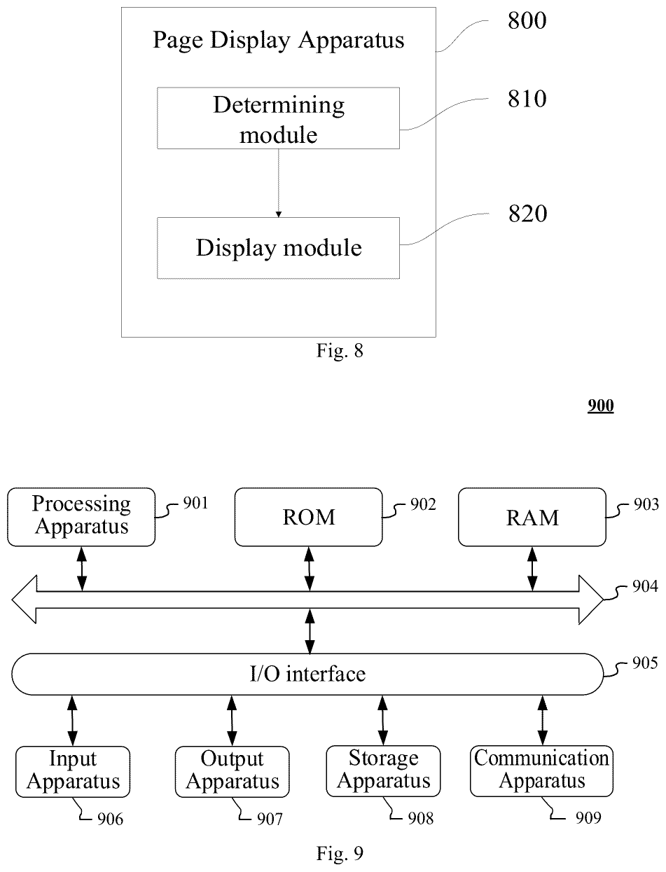

Based on the same concept, an embodiment of the present disclosure further provides a page display apparatus. As shown in FIG. 8, the page display apparatus 800 may include:
a determining module 810 configured to determine a target opening manner for a target page in response to a trigger operation on the target page within an application, wherein the target opening manner is used to represent whether to open the target page within the application; and
a display module 820 configured to display the target page based on the target opening manner.

By using the above page display apparatus, the target opening manner for the target page can be determined when the target page is triggered within the application, such that the target page can be displayed based on the target opening manner. Since the target opening manner is used to represent whether to open the target page within the application, the same target page may be opened and displayed within the application, or may be opened and displayed outside the application. Compared with the solution that the same page is generally displayed based on a default opening manner in the related art, the solution provided by the present disclosure can dynamically adjust the page opening manner of the application, thereby improving the flexibility of page display, and also improving the user experience.

In a possible implementation, the determining module 810 may include:
an obtaining sub-module configured to obtain, in response to the trigger operation on the target page within the application, configuration information of the target page and/or historical interaction matching information of a terminal device running the application, wherein the historical interaction matching information is used to represent interaction matching information for page interaction based on a historical page, and the historical page is a page with a same page type as the target page; and
a first determining sub-module configured to determine the target opening manner for the target page based on the configuration information and/or the historical interaction matching information.

In a possible implementation, the first determining sub-module may include:
a first determining unit configured to determine to open the target page within the application when the configuration information includes preset interaction configuration information; and
a second determining unit configured to determine to open the target page outside the application when the configuration information does not include the preset interaction configuration information.

In a possible implementation, the first determining sub-module may include:
a third determining unit configured to determine a historical interaction match degree based on the historical interaction matching information, wherein the historical interaction match degree is an interaction match degree for the page interaction based on the historical page when the historical page is displayed through a default browser in the terminal device running the application;
a fourth determining unit configured to determine to open the target page outside the application when the historical interaction match degree is greater than a preset first interaction match degree threshold; and
a fifth determining unit configured to determine to open the target page within the application when the historical interaction match degree is less than or equal to the first interaction match degree threshold.

In a possible implementation, the first determining sub-module may include:
a sixth determining unit configured to determine a historical interaction match degree and historical page content based on the historical interaction matching information, wherein the historical interaction match degree is an interaction match degree of page interaction based on the historical page when the historical page is displayed through a default browser in the terminal device running the application, and the historical page content is content of the historical page associated with page interaction information; and
a seventh determining unit configured to determine the target opening manner for the target page based on the historical interaction match degree and the historical page content.

In a possible implementation, the seventh determining unit may include:
a first determining sub-unit configured to determine to open the target page outside the application when the historical interaction match degree is greater than a preset second interaction match degree threshold;
a second determining sub-unit configured to determine to open the target page outside the application when the historical interaction match degree is less than or equal to the second interaction match degree threshold and the historical page content includes content of the target page; and
a third determining sub-unit configured to determine to open the target page within the application when the historical interaction match degree is less than or equal to the second interaction match degree threshold and the historical page content does not include the content of the target page.

In a possible implementation, the historical page content includes a domain name of the historical page, or a content identifier in the historical page.

In a possible implementation, the first determining sub-module may include:
an eighth determining unit configured to determine the target opening manner for the target page based on the historical interaction matching information when the configuration information does not include preset interaction configuration information.

In a possible implementation, the first determining sub-module may include:
a ninth determining unit configured to input the configuration information and/or the historical interaction configuration information into a prediction model, determine a predicted opening manner output by the prediction model as the target opening manner for the target page, wherein the prediction model is used to determine a page opening manner based on input information.

In a possible implementation, the determining module 810 may include:
a first determining submodule configured to determine to open the target page outside the application when the target page is unable to be opened within the application.

In the possible implementations, the second determining unit, the fourth determining unit, the first determining sub-unit, the second determining sub-unit or the first determining sub-module may be configured to determine to open the target page through the default browser in the terminal device running the application.

Based on the same concept, an embodiment of the present disclosure further provides a computer-readable medium having a computer program stored thereon, where the program, when executed by a processing apparatus, causes the steps of the method according to any one of the embodiments of the first aspect to be implemented.

Based on the same concept, an embodiment of the present disclosure further provides an electronic device. The electronic device may include:
a storage apparatus having a computer program stored thereon; and
a processing apparatus configured to execute the computer program in the storage apparatus to implement the steps of the method according to any one of the embodiments of the first aspect.

Referring to FIG. 9, FIG. 9 illustrates a schematic structural diagram of an electronic device 900 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 9 is merely an example, and should not pose any limitation to the functions and the range of use of the embodiments of the present disclosure.

As illustrated in FIG. 9, the electronic device 900 may include a processing apparatus 901 (e.g., a central processing unit, a graphics processing unit, etc.), which can perform various suitable actions and processing according to a program stored in a read-only memory (ROM) 902 or a program loaded from a storage apparatus 908 into a random-access memory (RAM) 903. The RAM 903 further stores various programs and data required for operations of the electronic device 900. The processing apparatus 901, the ROM 902, and the RAM 903 are interconnected by means of a bus 904. An input/output (I/O) interface 905 is also connected to the bus 904.

Usually, the following apparatus may be connected to the I/O interface 905: an input apparatus 906 including, for example, a touch screen, a touch pad, a keyboard, a mouse, a camera, a microphone, an accelerometer, a gyroscope, or the like; an output apparatus 907 including, for example, a liquid crystal display (LCD), a loudspeaker, a vibrator, or the like; a storage apparatus 908 including, for example, a magnetic tape, a hard disk, or the like; and a communication apparatus 909. The communication apparatus 909 may allow the electronic device 900 to be in wireless or wired communication with other devices to exchange data. While FIG. 9 illustrates the electronic device 900 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 909 and installed, or may be installed from the storage apparatus 908, or may be installed from the ROM 902. When the computer program is executed by the processing apparatus 901, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above- mentioned electronic device, or may also exist alone without being assembled into the electronic device.

The above-mentioned computer-readable medium carries one or more programs, and when the one or more programs are executed by the electronic device, the electronic device is caused to: determine a target opening manner for a target page in response to a trigger operation on the target page within an application, wherein the target opening manner is used to represent whether to open the target page within the application; and display the target page based on the target opening manner.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine- readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The above description is only a preferred embodiment of the present disclosure and an explanation of the technical principles used. Those skilled in the art should understand that the scope of disclosure involved in the present disclosure is not limited to the technical solutions formed by the specific combination of the above technical features, but should also cover other technical solutions formed by any combination of the above technical features or their equivalent features without departing from the above disclosure concept. For example, the above features are replaced with (but not limited to) technical features with similar functions disclosed in the present disclosure.

In addition, although the operations are depicted in a specific order, this should not be understood as requiring these operations to be performed in the specific order shown or in a sequential order. In certain environments, multitasking and parallel processing may be advantageous. Similarly, although several specific implementation details are included in the above discussion, these should not be interpreted as limiting the scope of the present disclosure. Certain features described in the context of separate embodiments can also be implemented in a single embodiment in combination. Conversely, the various features described in the context of a single embodiment can also be implemented in multiple embodiments individually or in any suitable sub-combination.

Although the subject matter has been described in language specific to structural features and/or method logic actions, it is to be understood that the subject matter defined in the appended claims is not necessarily limited to the specific features or actions described above. On the contrary, the specific features and actions described above are merely example forms of implementing the claims. Regarding the apparatus in the above embodiment, the specific manner in which each module performs the operation has been described in detail in the embodiment related to the method, and will not be elaborated here.

1. A page display method, comprising:
determining a target opening manner for a target page in response to a trigger operation on the target page within an application, wherein the target opening manner is used to represent whether to open the target page within the application; and
displaying the target page based on the target opening manner.

2. The method according to claim 1, wherein determining the target opening manner for the target page in response to the trigger operation on the target page within the application comprises:
obtaining, in response to the trigger operation on the target page within the application, configuration information of the target page and/or historical interaction matching information of a terminal device running the application, wherein the historical interaction matching information is used to represent interaction matching information for page interaction based on a historical page, and the historical page is a page with a same page type as the target page; and
determining the target opening manner for the target page based on the configuration information and/or the historical interaction matching information.

3. The method according to claim 2, wherein determining the target opening manner for the target page based on the configuration information comprises:
determining to open the target page within the application when the configuration information comprises preset interaction configuration information; or
determining to open the target page outside the application when the configuration information does not comprise the preset interaction configuration information.

4. The method according to claim 2, wherein determining the target opening manner for the target page based on the historical interaction matching information comprises:
determining a historical interaction match degree based on the historical interaction matching information, wherein the historical interaction match degree is an interaction match degree for the page interaction based on the historical page when the historical page is displayed through a default browser in the terminal device running the application; and
determining to open the target page outside the application when the historical interaction match degree is greater than a preset first interaction match degree threshold; or
determining to open the target page within the application when the historical interaction match degree is less than or equal to the first interaction match degree threshold.

5. The method according to claim 2, wherein determining the target opening manner for the target page based on the historical interaction matching information comprises:
determining a historical interaction match degree and historical page content based on the historical interaction matching information, wherein the historical interaction match degree is an interaction match degree of page interaction based on the historical page when the historical page is displayed through a default browser in the terminal device running the application, and the historical page content is content of the historical page associated with page interaction information; and
determining the target opening manner for the target page based on the historical interaction match degree and the historical page content.

6. The method according to claim 5, wherein determining the target opening manner for the target page based on the historical interaction match degree and the historical page content comprises:
determining to open the target page outside the application when the historical interaction match degree is greater than a preset second interaction match degree threshold;
determining to open the target page outside the application when the historical interaction match degree is less than or equal to the second interaction match degree threshold and the historical page content comprises content of the target page; or
determining to open the target page within the application when the historical interaction match degree is less than or equal to the second interaction match degree threshold and the historical page content does not comprise the content of the target page.

7. The method according to claim 5, wherein the historical page content comprises a domain name of the historical page, or a content identifier in the historical page.

8. The method according to claim 2, wherein determining the target opening manner for the target page based on the configuration information and the historical interaction matching information comprises:
determining the target opening manner for the target page based on the historical interaction matching information when the configuration information does not comprise preset interaction configuration information.

9. The method according to claim 2, wherein determining the target opening manner for the target page based on the configuration information and/or the historical interaction matching information comprises:
inputting the configuration information and/or the historical interaction matching information into a prediction model, and determining a predicted opening manner output by the prediction model as the target opening manner for the target page, wherein the prediction model is used to determine a page opening manner based on input information.

10. The method according to claim 1, wherein determining the target opening manner for the target page comprises:
determining to open the target page outside the application when the target page is unable to be opened within the application.

11. The method according to claim 3, wherein determining to open the target page outside the application comprises:
determining to open the target page through a default browser in the terminal device running the application.

12. An electronic device, comprising:
at least a processor, and
a non-transitory memory with instructions thereon,
wherein the instructions upon execution by the processor, cause the processor to:
determine a target opening manner for a target page in response to a trigger operation on the target page within an application, wherein the target opening manner is used to represent whether to open the target page within the application; and
display the target page based on the target opening manner.

13. The electronic device according to claim 12, wherein the processor is further caused to:
obtain, in response to the trigger operation on the target page within the application, configuration information of the target page and/or historical interaction matching information of a terminal device running the application, wherein the historical interaction matching information is used to represent interaction matching information for page interaction based on a historical page, and the historical page is a page with a same page type as the target page; and
determine the target opening manner for the target page based on the configuration information and/or the historical interaction matching information.

14. The electronic device according to claim 13, wherein the processor is further caused to:
determine to open the target page within the application when the configuration information comprises preset interaction configuration information; or
determine to open the target page outside the application when the configuration information does not comprise the preset interaction configuration information.

15. The electronic device according to claim 13, wherein the processor is further caused to:
determine a historical interaction match degree based on the historical interaction matching information, wherein the historical interaction match degree is an interaction match degree for the page interaction based on the historical page when the historical page is displayed through a default browser in the terminal device running the application; and
determine to open the target page outside the application when the historical interaction match degree is greater than a preset first interaction match degree threshold; or
determine to open the target page within the application when the historical interaction match degree is less than or equal to the first interaction match degree threshold.

16. The electronic device according to claim 13, wherein the processor is further caused to:
determine a historical interaction match degree and historical page content based on the historical interaction matching information, wherein the historical interaction match degree is an interaction match degree of page interaction based on the historical page when the historical page is displayed through a default browser in the terminal device running the application, and the historical page content is content of the historical page associated with page interaction information; and
determine the target opening manner for the target page based on the historical interaction match degree and the historical page content.

17. The electronic device according to claim 13, wherein the processor is further caused to:
determine the target opening manner for the target page based on the historical interaction matching information when the configuration information does not comprise preset interaction configuration information.

18. The electronic device according to claim 13, wherein the processor is further caused to:
input the configuration information and/or the historical interaction matching information into a prediction model, and determining a predicted opening manner output by the prediction model as the target opening manner for the target page, wherein the prediction model is used to determine a page opening manner based on input information.

19. A non-transitory computer-readable medium storing instructions that cause at least a processor to:
determine a target opening manner for a target page in response to a trigger operation on the target page within an application, wherein the target opening manner is used to represent whether to open the target page within the application; and
display the target page based on the target opening manner.

20. The non-transitory computer-readable medium according to claim 19, wherein the processor is further caused to:
obtain, in response to the trigger operation on the target page within the application, configuration information of the target page and/or historical interaction matching information of a terminal device running the application, wherein the historical interaction matching information is used to represent interaction matching information for page interaction based on a historical page, and the historical page is a page with a same page type as the target page; and
determine the target opening manner for the target page based on the configuration information and/or the historical interaction matching information.
